(19) United States
(12) Patent Application Publication
(10) Pub. No.: US 2016/0349787 A1
(43) Pub. Date: Dec. 1, 2016

(54) KNOB EXTENDER FOR A HORIZONTAL TILT WINDOW ASSEMBLY SUPPORT ARM

(71) Applicant: DONALD E. KING, GOLDEN, CO (US)

(72) Inventor: DONALD E. KING, GOLDEN, CO (US)

(21) Appl. No.: 14/726,876

(22) Filed: Jun. 1, 2015

(51) Int. Cl. G05G 1/02; E06B 3/32; E06B 3/38

(52) U.S. Cl. CPC G05G 1/025; E06B 3/38; E06B 3/325

(57) ABSTRACT

A knob extender for a knob of a horizontal tilt window guide assembly is provided. A rigid body has a proximal portion with an axial clear hole of a size sufficient to insert the knob in tight fitment. The knob is pivotally coupled to a lower end of a angular support arm for selectively engaging the lower end into a predetermined guide slot position of a horizontal tilt window guide. A travel limiting stop is positioned between the proximal and distal portions at a predetermined position so as to limit an axial distance of insertion travel of the knob within the clear hole so that a proximal face of the body is retained in a spaced relationship away from an interior surface of a front wall of a window frame while operating the knob extender to adjustably position the horizontal tilt window with respect to the predetermined guide slot.

### CROSS REFERENCE TO RELATED APPLICATIONS

None.

### STATEMENT OF FEDERALLY SPONSORED RESEARCH

No applicable.

### BACKGROUND OF THE INVENTION

1. Field of the Invention

The present invention relates to horizontal tilt window assemblies. In particular, it relates to a knob extender for use in leveraging a lower end of an angular horizontal tilt window support arm in to a predetermined position.

2. Description of the Related Art

Tilt window assemblies are well known in the art of recreational vehicles. One such example is the tilt window guide assembly which has been adapted and widely accepted for use in the Airstream™ brand of recreational and commercial travel trailers. There, the tilt window is selectively adjustable between an open and a closed position by positioning a lower end of an angular support arm into one of a series of three horizontal guide slots, which are formed in a window guide frame. The horizontal tilt window frame has an interior front wall and a window casing. The casing has opposite side walls. A pair of window guide frame members are oppositely attached, one each to an inner surface of each of the tilt window casing side walls. The window is operated by grasping a pair of small kidney shaped knobs. The knobs are connected to the lower ends of the support arms, through the front wall of the window frame, by a pair of bar members which protrude, a short distance, outwardly through a pair of vertical channels formed in the front side walls of the window frame. In operation, the lower ends of the angular support arms are operated either by pushing or pulling, and then lifting or dropping the pair of knobs by grasping one of each of the knobs with either hand.

While the foregoing tilt window operating assembly offers some utility, leveraging the window by grasping the knobs with one hand and pushing while urging the knobs upwardly is an awkward and difficult maneuver, especially while one is reaching over a fixture, such as a counter top, a cushion, or appliance to reach the font of the window frame. Thus, what is needed is tilt window leveraging extender assembly for adjusting the lower end of an angular support arm into a predetermined guide slot of a window guide when operating the tilt window in a range between the open and closed positions. The present invention satisfies these needs.

### BRIEF SUMMARY OF THE INVENTION

It is therefore an object of the present invention to provide a horizontal tilt window extender for leveraging a lower end of a horizontal tilt window angular support arm into a guide slot.

It is another object of the present invention to provide a horizontal tilt window extender assembly for leveraging a horizontal tilt window support arm into a guide slot of a travel trailer.

To overcome the problems associated with the prior art and in accordance with the purpose of the present invention, as embodied and broadly described herein, briefly, a knob extender for a knob of a horizontal tilt window guide assembly is provided. A rigid body has a proximal portion and a distal portion. The proximal portion has an axial clear hole. The clear hole is of a size sufficient to insert the knob in tight fitment. The knob is pivotally coupled to a lower end of a horizontal tilt window support arm, with a bar, for selectively engaging the lower end of the support arm into a predetermined guide slot position of a tilt window guide. A travel limiting stop is positioned in a recess of the body at a predetermined positioned between the proximal and distal portions. The predetermined position is defined so as to limit an axial distance of an insertion travel of the knob within a recess of the clear hole so that a proximal face of the body is retained in a spaced relationship away from an interior surface of a front wall of a window frame while operating the knob extender to adjustably position the horizontal tilt window with respect to the predetermined guide slot.

Additional advantages of the present invention will be set forth in part in the description that follows and in part will be obvious from that description or can be learned from practice of the invention. The advantages of the invention can be realized and obtained by the apparatus particularly pointed out in the appended claims.

### BRIEF DESCRIPTION OF THE SEVERAL VIEWS OF THE DRAWINGS

The accompanying drawings. which are incorporated in and which constitute a part of the specification, illustrate at least one embodiment of the invention and, together with the description, explain the principles of the invention.

FIG. 1a is an isometric illustration of an embodiment of the present invention showing the knob inserted into a pipe body with a rounded handle at the distal end of the body.

FIG. 1b is an isometric illustration of the embodiment according to FIG. 1, but is a further illustration of a preferred embodiment showing a spring clip used to retain the knob after insertion into the body.

FIG. 1c is an isometric illustration of yet another embodiment of the present invention showing a rectangular hollow body, a rectangular handle with upper and lower concave surfaces adapted to conform to the digits of a hand, and where the stop is a block inserted into an interior recess of the extender body.

FIG. 2 is an isometric outer illustration of the knob extender assembly showing the knob extender, coupled to the support arm, the low end of the support arm positional in the guide slots, the guide frame, a section of the horizontal tilt window, and pivotal connection of the section of the horizontal tilt window with an upper end of the support arm.

FIG. 3 is an isometric illustration showing an inner view of the knob extender assembly showing the inner wall of the window frame, the knob extender, the knob coupled to the support arm, a portion of the horizontal tilt window, and pivotal connection of the horizontal tilt window with an upper end of the support arm.

FIG. 4 is an isometric front view of a tilt window assembly when fit to a travel trailer body.

FIG. 5 is an isometric illustration of an embodiment of the invention showing the extender in relation to a spring clip embodiment biased on an upper surface of the knob.

FIG. 6 is an isometric illustration showing the knob fully inserted through the clear hole and being retained by the spring clip.

### DETAILED DESCRIPTION OF THE DRAWINGS

Unless specifically defined otherwise, all technical or scientific terms used herein have the same meaning as commonly understood by one of ordinary skill in the art to which this invention belongs.

Although any methods and materials similar or equivalent to those described herein can be used in the practice or testing of the present invention, the preferred methods and materials are now described. Reference now will be made in detail to the presently preferred embodiments of the invention, examples of which are illustrated in the accompanying drawings, wherein like numerals represent like features.

The present invention provides a knob extender for leveraging a knob 25 of a horizontal tilt window guide assembly. The window guide 28 is attached to each of the opposite side walls 20 of a horizontal tilt window frame casing. Once such example of the window guide assembly, for use with the present invention, is the assembly found on the AIRSTREAM™ brand of travel trailers 32. The extender has a rigid body 10. The rigid body 10 may be of any material well known in the art, but is desirably formed of a metal material, such as aluminum or stainless steel, and is desirably shaped either as a pipe or hollow rectangular tube. The rigid body 10 has a proximal portion 13. The proximal portion 13 has an axial clear hole, or bore, which extends either fully or partially through the body 10 to fully encompass the knob 25 and knob bar 23. The clear hole is of a size or shape which is sufficient so that the knob 25 is fully insertional into the clear hole so that the knob 25 fits in a substantially tight fitment.

The knob 25 is attached to the knob bar 23. The knob bar 23 extends outwardly from a channel in the front wall 22 of the window frame. The bar 23, is pivotally coupled to a lower end of a horizontal tilt window angular support arm 24. The support arm 24 is pivotal for selectively engaging the lower end of the support arm 24 into a predetermined guide slot 29 position of a horizontal tilt window 30 guide 28. The upper end of the support arm 24 is pivotally connected to a bracket 26. The bracket 26 is fastened to the window 30 glass frame.

A travel limiting stop 14 is positioned in the body 10, at a predetermined positioned, between the proximal 13 and distal portions. The predetermined position is defined so that the stop 14 limits the axial travel insertion distance of the knob 25, within a recess of the clear hole, so that the proximal face 13 of the body 10 is retained in a spaced relationship away from an interior surface of the front wall 22 of a window frame while operating the knob extender to adjustably leverage the lower end of the angular support arm 24 into a predetermined guide slot 29.

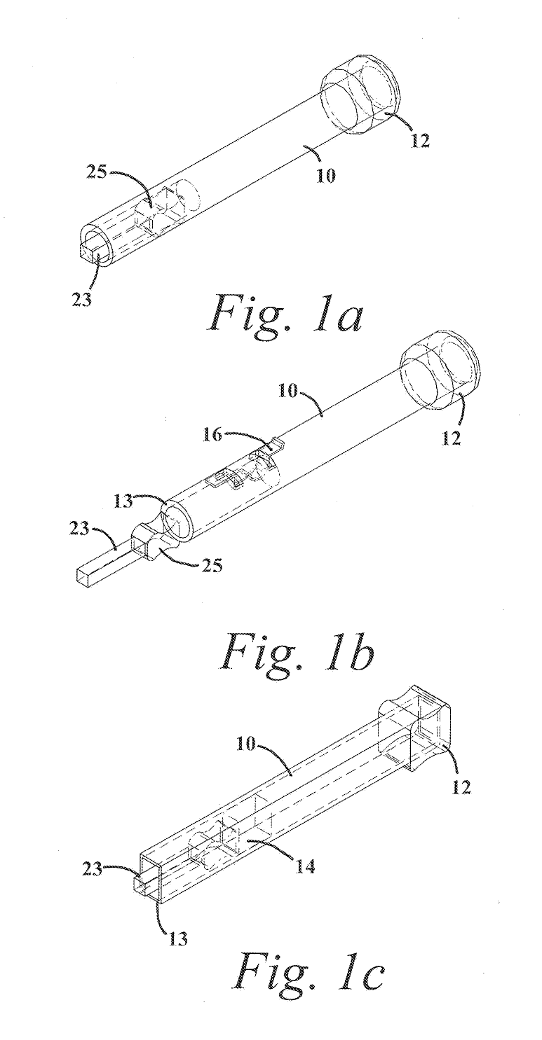

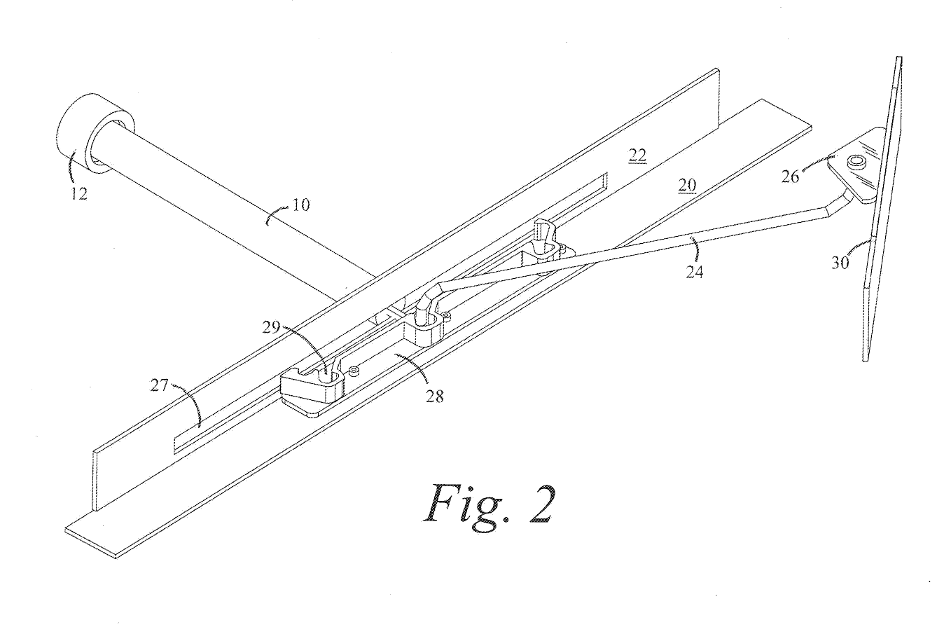

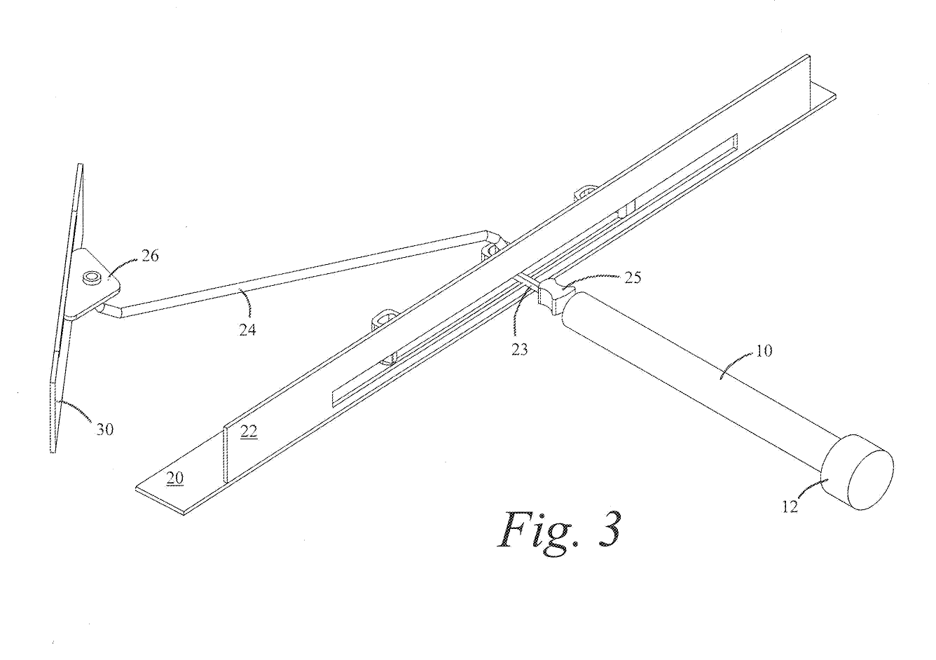

Referring now to FIGS. 1a-1c, the travel limiting stop 14 may be of any stop which is well known in the art such as a measured axial bore depth of the clear hole from the proximal face 13 of the body 10 (FIG. 1a), a flanged restriction portion of the inside diameter (not shown), or as a block 14 connected within the clear hole at the predetermined distance (FIG. 1c).

The handle 25 may, but need not, include a rounded or rectangular end formation being generally shaped and/or a cushioned and configured in function with an inner recess to conform to an outer shape of the body 10. As illustrated in FIGS. 1c and 6, in a presently preferred embodiment, the handle 12 is desirably formed with a rectangular shaped configuration having concave contours in the top and bottom surfaces to aid in lifting, pushing and pulling of the handle extender body 10 with the digits of each hand.

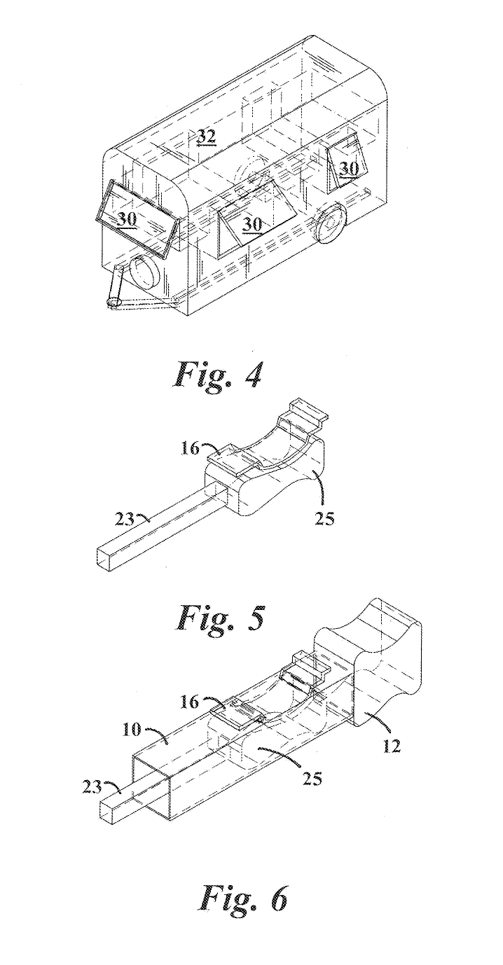

The handle extender may, but need not, include a knob 25 retaining member. The retaining member may be a clip, spring or pin. For example, as shown in FIGS. 1b, 4, and 6, the body 10 desirably includes a pair of cut-out portions, in a spaced relationship, positioned in a top surface for receiving opposite ends of a spring clip 16. The spring clip 16 desirably has proximal and distal ends with a central bent deformation between the opposite ends. The proximal end is attached to an outer surface of the body 10, such as with a rivet or weld. The deformation of the spring clip 16 desirably extends downwardly into a central portion of the recess of the body 10 to bias against an outer surface portion of the knob 25, as the knob 25 is inserted into the axial clear hole of the body 10. The distal end of the spring clip 16 is operable and may, but need not, include an upwardly bent flange formation for ease in actuation of the clip 16, upwardly, to release the clip 16 from the surface of the knob 25, while removing the knob 25 from the body 10.

While the present invention has been described in connection with the illustrated embodiments, it will be appreciated and understood that certain modifications may be made without departing from the true spirit and scope of the invention.

1. A knob extender for a horizontal tilt window, comprising:
a rigid body having a proximal portion and a distal portion, said proximal portion having an axial clear hole being of a size sufficient to insert a knob of a horizontal tilt window guide assembly, said extender being operable for selectively engaging said assembly into a predetermined guide slot position of a tilt window guide when attached to a sidewall of a horizontal tilt window frame casing; and
b) a stop means positioned in a recess of said body at a predetermined position between said proximal and distal portions, said predetermined position being defined so that a proximal face of said body is retained in a spaced relationship away from an interior surface of a front wall of a tilt window frame while operating said knob extender to adjustably position said horizontal tilt window with respect to said predetermined guide slot.

2. The knob extender according to claim 1, further comprising, a handle connected to said distal portion.

3. The knob extender according to claim 1, further comprising, a clip attached to said body being adapted for biasing against said knob so that said body is capable of releasable retention of said knob within said clear hole.

4. A knob extender for a knob of a horizontal tilt window guide assembly, comprising:
a) a rigid body having a proximal portion and a distal portion, said proximal portion having an axial clear hole being of a size sufficient to insert said knob in tight fitment therein, said knob being further pivotally coupled, with a bar, to a lower end of a horizontal tilt window angular support arm for selectively engaging said lower end of said support arm into a predetermined guide slot position of a tilt window guide; and
b) a stop means positioned in a recess of said body at a predetermined position between said proximal and distal portions, said predetermined position defined so as to limit an axial distance of insertion travel of said knob within a recess of said clear hole so that a proximal face of said body is retained in a spaced relationship away from an interior surface of a front wall of a tilt window frame while operating said knob extender to adjustably position said horizontal tilt window with respect to said predetermined guide slot.

5. The knob extender according to claim 4 further comprising, a handle connected to said distal portion.

6. The knob extender according to claim 4, further comprising a clip attached to said body being adapted for biasing against said knob so that said body is capable of releasable retention of said knob within said clear hole.

7. The knob extender according to claim 4, wherein said guide includes at least three guide slots.

8. The knob extender according to claim 4, wherein said guide is attached to a side wall of a travel trailer window frame casing.

9. The knob extender according to claim 4, wherein said body is a tube having square inside and outside corners.

10. The extender according to claim 4, wherein the body is a pipe and the stop is a block.

11. The knob extender according to claim 9, wherein said handle has a top and bottom walls including concave shaped surfaces adapted for receiving a digits of a hand.

12. In combination with a knob being pivotally coupled, with a bar, to a lower end of a horizontal tilt window angular support arm for selectively engaging a lower end of said support arm into a predetermined guide slot position of a tilt window guide of a travel trailer horizontal tilt window, a knob extender, comprising:
a) a rigid body having a proximal portion and a distal portion, said proximal portion having an axial clear hole being of a size sufficient to insert said knob in tight fitment therein; and
b) a stop means positioned in a recess of said body at a predetermined position between said proximal and distal portions, said predetermined position defined so as to limit an axial distance of insertion travel of said knob within a recess of said clear hole so that a proximal face of said body is retained in a spaced relationship away from an interior surface of a front wall of a tilt window frame while operating said knob extender to adjustably position said horizontal tilt window with respect to said predetermined guide slot.

13. The knob extender according to claim 12, further comprising, a handle connected to said distal portion.

14. The knob extender according to claim 12, further comprising a clip attached to said body being adapted for biasing against said knob so that said body is capable of releasable retention of said knob within said clear hole.

15. The knob extender according to claim 12, wherein said guide includes at least three guide slots.

16. The knob extender according to claim 12, wherein said body is a tube having square inside and outside corners.

17. The extender according to claim 12, wherein the body is a pipe and the stop is a block.

18. The knob extender according to claim 13, wherein said handle has a top and bottom walls including concave shaped surfaces adapted for receiving a digits of a hand.
